(19) United States
(12) Patent Application Publication
(10) Pub. No.: US 2009/0067470 A1
(43) Pub. Date: Mar. 12, 2009

(54) METHOD FOR HEAT TREATMENT OF POWDERY MATERIALS

(75) Inventor: Martin Mitzkat, Cliousclat (FR)

Correspondence Address: DENNISON, SCHULTZ & MACDONALD, 1727 KING STREET, SUITE 105, ALEXANDRIA, VA, 22314, US

(73) Assignee: REVTECH, Charmes sur Rhone (FR)

(21) Appl. No.: 12/281,826

(22) PCT Filed: Oct. 15, 2007
(86) PCT No.: PCT/FR07/52144

§ 371 Date: Sep. 5, 2008

(30) Foreign Application Priority Data
Dec. 21, 2006 (FR) 06 55793

(51) Int. Cl. F27B 9/04; B01J 8/12; F27D 7/02; F27B 9/06; F27B 9/32; F27D 11/02; F27D 3/10

(52) U.S. Cl. 373/111; 373/115; 373/119; 373/136

(57) ABSTRACT

The present invention relates to a method for heat treatment of powdery products (1), in particular powders, characterized in that said products are heated right up to a temperature of at least 700° C. in a passage tube (5) for current, positioned tilted with respect to a horizontal plane (P) and preferably substantially vertically with respect to this plane, said products flowing in said tube essentially by gravity. A device for applying this method is also described.

The present invention relates to a method for heat treatment and more particularly for heating powdery products and materials, and powders used in industry, in particular in chemical industries, and in the building industry for example.

Continuous reheating of powdery products in industry is a very wide field with predominance of bulky mechanical equipment such as rotary ovens and fluidized beds which use an external action (rotation, vibration) in order to move forward and mix particles of powders during their rise in temperature. There also are mechanical advance techniques which directly act on the product such as Archimedes's screw or band ovens. In practically all these cases, the heating sources are fossil fuels such as heavy fuel oil or natural gas.

Heating powdery products is more difficult than heating liquids because these products have to be stirred during their rise in temperature in order to reduce their heating time. A typical apparatus for performing this operation is a rotary oven which stirs the product bed by rotation of the cylinder. A fluidized bed obtains the same result by having a stream of air pass through the product in order to make it fluid and to thereby improve its internal heat exchange coefficients. With vibrating systems a powdery product may be fluidized, but with global exchange coefficients which are located between those of rotary ovens and those of air-fluidized beds.

The temperatures obtained with rotary ovens may be high if the inside of the cylinder is coated with adequate materials of the refractory brick type. But in this case the apparatus becomes very heavy and bulky because the cylinder which is rotating must not yield under the effect of the weight or of the temperature. A typical example of these ovens is a cement plant oven.

A fluidized bed may be used for obtaining high temperatures, even at the combustion level such as in the example of a burner with a fluidized bed in an electric power plant where the product to be heated is the actual fuel.

These devices are bulky and require a second system capable of providing the energy required for heating the product, either as a hot air generator, or burners in direct contact with the product or the heating surface. Yield is often low because large amounts of air are applied and disposed of after treatment. Additional investments are required for recovering this heat (high temperature exchangers, etc.)

The object of the invention is to obtain an improved method and device capable of allowing any type of powdery materials and powders to be treated, even the most fine at temperatures ranging right up to 1,600° C.-2,000° C. without the drawbacks of traditional heating systems mentioned hereinbefore.

This object is achieved according to a first aspect of the invention by means of a method for heat treatment of powdery products, in particular of powders, characterized in that said products are heated, notably right up to a temperature of at least 700° C., in a passage tube for current positioned tilted with respect to a horizontal plane, and preferably substantially vertically with respect to this plane, said products flowing into said tubes essentially by gravity, and wherein said products are heated in said tube (5) by heating the walls of the tube by the Joule effect, said tube being connected and directly powered by an electric power supply device (6) with which the walls of said tube may be heated by the Joule effect.

It is understood that the heating of the products is therefore essentially accomplished by radiation and, if necessary, by contact with the wall in the case of a tilted tube.

The method of the invention is therefore based on the use of the passage tube for a static current, with which the walls of the tube may be heated by the passage of a suitable electric current, further designated as “impedance heating tube”. The temperature obtained on the tube depends on the amount of current passing through the tube and on the grade of the alloy used.

According to the method of the invention, said products are heated in said tube right up to a temperature of at most 2,000° C., and preferably a temperature comprised between 150° and 1,500° C., notably between 800° C. and 1,200° C. The tube is placed vertically or tilted and the powder is simply poured in at the desired rate. Through the action of gravity, the product exits at the bottom of the tube after having been very strongly heated.

The heat treatment method according to the invention is particularly advantageous with regard to the known methods from the state of the art. Indeed, with it, very high temperatures for treating the powders may be attained, by which the treatment (heating) times may be considerably reduced from a few tens of minutes in rotating or vibrating ovens to a few seconds with the method of the invention.

Further, this novel method allows any powders and powdery products to be treated while getting rid of the usual adhesive bonding and skin effect problems encountered with powders of very small particle size, i.e. less than 10 μm and this with high treatment rates and high energy yield, in a reduced space because of the simplicity of the treatment device to be applied.

With the present invention, it is possible to achieve better controlled heating and if necessary, more homogenous heating between the different portions of the surface of the tube, and to therefore obtain products which are more homogenously and uniformly heated inside the tube and notably more rapidly with optimum energy yield.

In particular, with the present invention, it is possible to avoid overheating spikes of the tube, notably in the case of heat-sensitive and/or very fine treated products, notably with a size less than 200 μm, which may be degraded locally. By this homogenous heating of the surface of the tube, it is also possible to avoid problems of mechanical strength of the tube, while avoiding the risks of localized melting.

Depending on the type of treated product and on the characteristics of the passage tube used for the current for applying the method, the electric power supplied to said tube is comprised between 10 kilowatts (kW) and 5 megawatts (MW).

Advantageously, the temperature of said products treated inside said tube may also be regulated by regulating the electric power supplied to said tube.

In one embodiment, the tube is uniformly heated over throughout its length and throughout its periphery.

However, in an advantageous embodiment, the upper end of the wall of the tube is heated, preferably over a length equal or less than a third of the total length of the heated tube, to a higher temperature than that of the uniformly heated remainder of the tube, i.e. the remaining low portion of the tube.

Thus, the product introduced at the top of the tube is raised more rapidly to the desired temperature.

The introduction device comprising a feed screw is advantageous because the feed rate of the product may be accurately controlled regardless of the applied gas flow rate.

Advantageously, in particular if the tube is tilted, a gas is caused to flow with the current or against the current of said products treated in said tube during the heating of said products.

According to the method of the invention, the flow rate of said products treated inside said passage tube for the current is comprised between 0.01 metric tons/hour and 10 metric tons/hours, depending on the nature of the treated products and on the desired heating temperature of said products, and the average dwelling time of the products in the tube is comprised between 0.5 second and 2 minutes.

Another aspect of the invention consists of providing a device for applying the method of the invention, this device including a so-called passage tube for current positioned tilted with respect to the horizontal plane and preferably substantially vertically with respect to this plane, the walls being able to be heated by the Joule effect by a device for supplying electric power to said tube, connected to said tube, and a device for injecting so-called powdery materials into said tube laid out so that said products introduced into said tube by said injection device flow into said tube, essentially by gravity.

Such a device is particularly advantageous because it has negligible ground occupation as compared with rotary ovens used in the state of the art, as well as much lower investment cost, not to mention very easy applicability in particular.

In an embodiment, said passage tube for current is tilted by an angle a comprised between 30° and 90° with respect to said horizontal plane (P).

By applying a tilted tube, the total height of the device may be reduced and especially the dwelling time of the products in the tube may be extended, because the latter are in contact with the interior surface of the wall of the tube and roll on the latter, instead of directly falling into empty space inside a vertical tube. This embodiment with a tilted tube is suitable for powdery products which have rheology providing sufficient flowability of the product on the wall.

According to another feature of the invention, said products are introduced into said tube via an injection device comprising a honeycomb valve or a feed screw downstream from a feed hopper, and means for injecting gas at the upper end of the tube and/or between the valve or said feed screw and said tube.

Preferred features of this device notably reside in the fact that:
it includes means for injecting gas inside said tube in order to cause said gas to flow with the current or against the current of the product injected into said tube by said injection device.
it includes means for regulating the electrical power delivered by said power supply device to said tube.

Further, preferably, said passage tube for current is connected to said electrical power supply device at a plurality of connection points distributed throughout the length of said tube, so as to substantially heat the whole wall of the tube uniformly.

In an advantageous embodiment the electrical power supply device comprises a low voltage transformer, preferably with a voltage less than 100 V, still preferably 48 V, said tube being connected to said transformer through at least 2 connecting cables.

For single- or two-phase current, 2 or 3 connecting cables are used. For a three-phase current, 4 connecting cables are used corresponding to the 3 phases of the electrical current and to the ground wire.

Generally, the connection points are uniformly distributed over the length of the tube to be heated, i.e. distributed at equal distances from each other successively.

However, still advantageously, the distance between the first two connection points, in the upper portion of the tube is smaller than that between the other connection points substantially distributed equidistantly in succession over the remainder of the length of the heated tube, preferably a distance between said first two connection points with a 10 to 30% smaller length than the uniform distribution distance of the other connection points, and the thickness of said tube between both said first connection points is less than the thickness of the remainder of the tube, preferably corresponding to a 10 to 30% reduction in thickness relatively to that of the remainder of the tube.

With this, the upper portion of the tube may be further heated between the first two connection points, and therefore the product introduced into the tube at the top of the tube may be heated more rapidly. By reducing the thickness of the tube, it is possible to retain identical electric resistances between the different connection points so as not to unbalance the phases of the supplied current. Heating to a higher temperature the upper portion of the tube results from the fact that the same electric power is delivered over a tube portion with a reduced length relatively to the other two portions between the other connection points substantially equidistant from each other and in succession.

In this way, a very powerful heating method and system is obtained (up to several megawatts of injected electric energy) for very low bulkiness and is very simple to apply thanks to the absence of any mechanical and thermal system. Any type of homogenous and non-clogging powdery product may be treated.

The tube consists of an electrically conducting material. According to a preferred feature of the device of the invention, said passage tube for current consists of an amagnetic metal material such as a non-magnetic steel alloy, preferably austenitic stainless steel or nickel, chromium, iron, aluminium alloys, for example Inconel or Monel. Alternatively, in order to notably attain very high temperatures, the tube may consist of conducting ceramics, for example based on silicon carbide, or the tube may further consist of a material based on carbon in a conductive crystalline form, such as graphite.

Advantageously, in order that the method of the invention may easily be applied, said passage tube for current further has a length comprised between 2 and 50 m, preferably 5 to 30 m, and a diameter comprised between 20 and 220 mm, and a wall thickness from 2 to 10 mm.

Other features of the present invention will become better apparent upon reading the detailed description which follows, made in a non-limiting way with reference to the single appended figure, illustrating a device for heating powdery products allowing the method of the invention to be applied in a preferred embodiment.

This device includes a passage tube for current 5 preferably hung from or supported by struts so as to be set up with an angle a comprised between 30° C. and 90° (vertical) with respect to a horizontal plane P corresponding to the ground and more generally to the building plane of the device. When, as in the illustrated example, the tube 5 is positioned totally vertically with respect to the plane P, this facilitates flow of the treated product into the tube right up to the outlet 7 of the latter and it is possible to obtain very good treatment rates, the advantage of a more tilted arrangement, right up to an angle of 30° for example, being the reduction in the total height of the device.

The passage tube for current 5 is electrically connected through lines 61 to an electrical power supply device 6 capable of delivering a power supply voltage comprised between 1 V and 500 V. Generally, the lines 61 are regularly connected throughout the length of the tube 5 so as to obtain a homogenous distribution of electrical energy in the tube 5 and uniform heating of the wall of the latter by the Joule effect, the electrical power injected into the tube by the power supply device 6 may vary between 10 kW and 5 MW depending on the length and on the resistivity of the tube 5.

Power regulators (not shown) allow the amount of energy injected into the tube 5 to be adjusted and the heating temperature of the latter to be regulated, which may be raised right up to 1,600° C. to 2,000° C. depending on the nature of the tube 5.

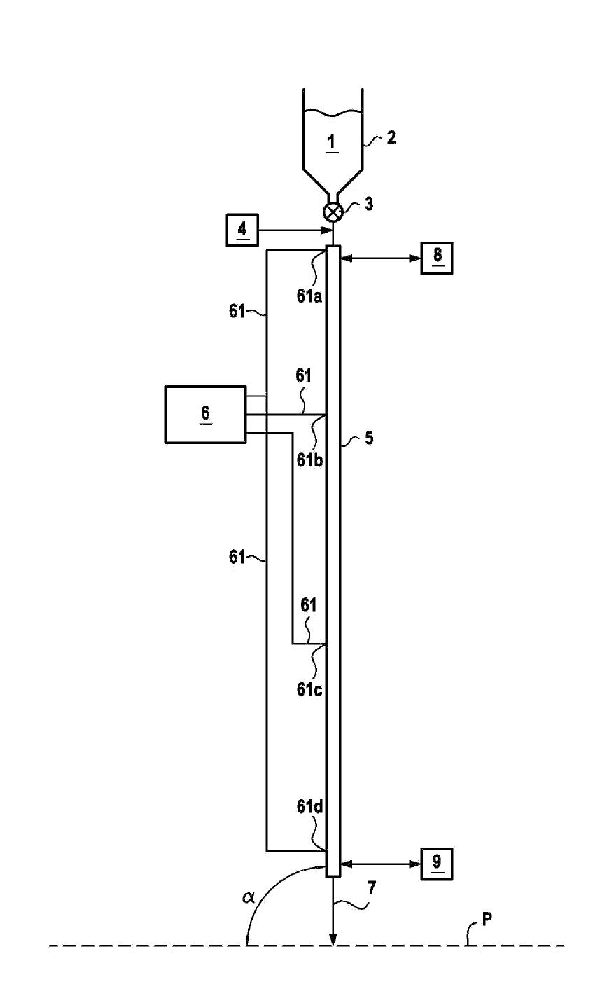

In an embodiment, the electrical power supply device comprises a low voltage transformer powered with a three-phase 48 V current. The transformer is connected to the tube through 4 connecting cables 61, corresponding to the three phases and to the ground. In order to further heat the upper portion of the tube, so as to heat the product more rapidly, in FIG. 1, the distance between the first two connection points 61a and 61b was shortened, the other connection points 61c and 61d being regularly distributed, i.e. the distances between the points 61b-61c and 61c and 61d are identical but larger than those between 61a-61b.

In order to deliver a same electrical power on a reduced tube portion, while retaining the same electrical resistance in order to preserve balance between the phases, i.e. in order to retain the same electrical resistance between the different successive connecting points, the thickness of said upper portion is reduced between the first two connection points 61a and 61b, in a same proportion as the reduction in distance.

Regulation of the temperature of the tube is achieved by modulating the electrical power injected into the walls of the tube. The transformer is driven by a power dimmer using thyristors operating in a fast wave train mode. The injected power may thereby be modulated by on/off pulses every 10 to 40 cycles for example. A control loop consists of a thermocouple probe and a PID type controller, connected to said dimmer. The thermocouple probe may be placed either in the product flow or more generally on the wall of the tube. This type of regulation provides accurate control of the temperature of the tube to within +/−1° C., because the heat inertia of the installation is very low.

The tube 5 is preferably made in an amagnetic metal alloy in order to avoid the skin effect, where current is concentrated on the outer surface of the tube, a particularly perturbing phenomenon with the very strong current injected into the tube. In the simplest way, the passage tube for current 5 consists of stainless steel in a currently available diameter. This diameter is practically selected according to the heated product, the desired flow rate and the dwelling time in the tube.

The heat treatment method and device of the invention allows, according to the first completed tests, any type of powdery product and powders to be treated at flow rates comprised between 10 kg/h and 10 T/h, the tube diameters 5 used may vary from between 20 mm and 220 mm for tube lengths comprised between 10 m to 50 m and with a thickness from 2 to 6 mm.

As an example, a DN50 tube (Øext 60.3×2.9 mm thick) may be used for heating a zinc oxide powder with specific gravity μ=1,200 kg/m³ at a flow rate of 1 T/h, or a DN65 tube (Øext 76×2.9 mm thick) for heating a nickel oxide powder of specific gravity μ=450 kg/m³ at a flow rate of 1.5 T/h.

At the upper end of the tube 5 is located a hopper 2 for receiving the product 1 to be treated and a device for injecting said product 1 into the tube 5 including a honeycomb valve 3 combined with first cold gas injection means 4 between said valve 3 and the inlet of the tube 5. This gas may be a reactive gas, compressed air, or an inert gas and allows the honeycomb valve to be thermally isolated and protected against the evolved heat by the high temperature of the tube 5 when it is in operation.

In an alternative use, the honeycomb valve 3 is replaced with a feed screw.

In a complementary way, it is also possible to provide as illustrated in the figure, second means for injecting and/or sucking gases 8, 9 at the upper end and/or the lower end of the tube 5, respectively, in order to inject and cause said gas to flow, which may be the same as the gas coolant, against the current or preferably with the current of the product treated in the tube.

Such a co-current or counter-current gas flow allows several possibilities such as the discharge of gas effluents, inertization of the device and contacting with a reactive gas.

A heat treatment example capable of being accomplished according to the method of the invention relates to the sintering of metal oxides such as nickel oxide.

This product appears as a powder, the density of which is of the order of 0.3 kg/l with a particle size of about 5 μm. The measured specific surface area of these powders is of the order of 20 m²/g.

Now, their use in industry, notably for coating operations, requires reduction of the specific surface area to about 5 m²/g and reduction of the specific gravity to about 0.45 kg/l.

In order to obtain this result, the powder should be heated to a temperature above 800° C. for a short period of time.

This heating may be achieved according to the method of the invention in a vertical passage tube 5 for current, as illustrated in the single enclosed figure, for example consisting of Inconel with a diameter of 60 mm for a length of 12 m.

The nickel oxide powder is introduced into the tube 5, positioned vertically, at a flow rate of 200 kg/h and is heated to a temperature of the order of 1,000° C. attained very rapidly, i.e. with a dwelling time of a few seconds inside the tube 5, and in practice less than 10 seconds.

During the flow of the powders in the tube 5, with a small co-current of nitrogen, the gas effluents released by the heating of the powders may be cleared, without perturbing the overall operation of the device.

At the outlet 7 of the heating tube, the nickel oxide powders are recovered after heating with a specific surface area and a specific gravity, which are satisfactory for their use.

1. A method for heat treatment of powdery products (1), in particular of powders, characterized in that said products are heated by the flow of said products in a passage tube (5) for current, positioned tilted with respect to a horizontal plane (P), and preferably substantially vertically with respect to this plane, said products flowing into said tube essentially by gravity, and wherein said products are heated in said tube (5) by heating the walls of the tube by the Joule effect, said tube being connected and directly powered by an electric power supply device (6) with which the walls of said tube may be heated by the Joule effect.

2. The method according to claim 1, wherein said products (1) are heated in said tube (5) right up to a temperature of at most 2,000° C., and preferably to a temperature comprised between 150 and 1,500° C.

3. The method according to claim 1, wherein said passage tube (5) for current is tilted by an angle a comprised between 30° and 90° with respect to said horizontal plane (P).

4. The method according to claim 3, wherein the electric power supplied to said tube (5) is comprised between 10 kilowatts and 5 megawatts.

5. The method according to claim 3, wherein the temperature of said products treated inside said tube is controlled by regulating the electric power supplied to said tube.

6. The method according to claim 1, wherein the upper end of the wall of the tube is heated to a higher temperature than that of the uniformly heated remainder of the tube.

7. The method according to claim 1, wherein a gas is caused to flow with the current or against the current of said products treated in said tube (5) during the heating of said products.

8. The method according to claim 1, wherein said powdery products have an average particle size less than 200 μm.

9. A device for applying the method of claim 1, including a so-called passage tube (5) for current, positioned tilted with respect to a horizontal plane (P) and preferably substantially vertically with respect to this plane, a so-called electric power supply device (6) connected to said tube, allowing the walls to be heated by the Joule effect, and a device for injecting said powdery materials into said tube laid out so that said products introduced into said tube by said injection device flow into said tube essentially by gravity.

10. The device according to claim 9, wherein said passage tube (5) for current is tilted by an angle a comprised between 30° and 90° with respect to said horizontal plane (P).

11. The device according to claim 9, wherein said passage tube (5) for current is connected to said electric power supply device (6) at a plurality of connection points distributed throughout the length of said tube so as to heat the whole wall of the tube substantially uniformly.

12. The device according to claim 9, wherein the electric power supply device comprises a low voltage transformer, preferably at a voltage less than 100 V, still preferably 48 V, said tube being connected to said transformer through at least 2 connection cables (61).

13. The device according to claim 12, wherein the tube is powered with an electrical three-phase current, said tube being connected to said transformer through 4 connecting cables (61).

14. The device according to claim 12, wherein the distance between the first two connection points (61a, 61b), in the upper portion of the tube is smaller than that between the other connection points (61c, 61d) substantially distributed equidistantly from each other in succession over the remainder of the length of the heated tube, preferably a distance between said first two connection points with a 10 to 30% smaller length than the distance between the other equidistant successive connection points, and the thickness of said tube between both said first connection points is less than the thickness of the remainder of the tube, preferably corresponding to a 10 to 30% reduction in thickness relatively to that of the remainder of the tube.

15. The device according to claim 9, wherein said injection device includes a honeycomb valve (3) or a feed screw downstream from a feed hopper (2) and means (8, 4) for injecting gas at the upper end of the tube and/or between said valve or said feed screw and said tube.

16. The device according to claim 9, further including means for injecting gas inside said tube so as to cause said gas to flow with or against the current of the products injected into said tube by said injection device.

17. The device according to claim 9, wherein the constitutive material of said tube is a non-magnetic alloy of steel, silicon carbide or carbon as graphite.

18. The device according to claim 9, wherein said passage tube for current has a length comprised between 2 and 50 m, preferably 5 to 30 m.

19. The device according to claim 9, wherein said passage tube for current has a diameter comprised between 20 and 220 mm and a wall thickness from 2 to 10 mm.
